(19) United States
(12) Patent Application Publication
(10) Pub. No.: US 2006/0263652 A1
(43) Pub. Date: Nov. 23, 2006

(54) Fuel cell system relative humidity control

(76) Inventor: Victor W. Logan, Naples, NY (US)

Correspondence Address: Cary W. Brooks;General Motors Corporation, Mail Code 482-C23-B21, P.O. Box 300, Detroit, MI, 48265-3000, US

(21) Appl. No.: 11/130,806

(22) Filed: May 17, 2005

(51) Int. Cl. H01M 8/04

(52) U.S. Cl. 429/13; 429/22; 429/26; 429/24

(57) ABSTRACT

Operating strategy for a fuel cell system controls the hydration level of the membranes in the fuel cells and achieves a desired operational performance. The membrane hydration level is managed by controlling the relative humidity of the cathode gas flowing through the cathode flow path. Targeted relative humidity set points for the cathode gas entering and exiting the cathode flow path are established based on the water vapor in the cathode gas. Temperature set points for the cathode gas to achieve the targeted relative humidity are established. The coolant supply subsystem is operated to cause the required cathode gas temperatures to be achieved.

### FIELD OF THE INVENTION

The present invention relates to fuel cells and, more particularly, to controlling the relative humidity in fuel cells.

### BACKGROUND OF THE INVENTION

Fuel cells are used as a power source for electric vehicles, stationary power supplies and other applications. One known fuel cell is the PEM (i.e., Proton Exchange Membrane) fuel cell that includes a so-called MEA (“membrane-electrode-assembly”) comprising a thin, solid polymer membrane-electrolyte having an anode on one face and a cathode on the opposite face. The MEA is sandwiched between a pair of electrically conductive contact elements which serve as current collectors for the anode and cathode, which may contain appropriate channels and openings therein for distributing the fuel cell's gaseous reactants (i.e., H₂ and O₂/air) over the surfaces of the respective anode and cathode.

PEM fuel cells comprise a plurality of the MEAs stacked together in electrical series while being separated one from the next by an impermeable, electrically conductive contact element known as a bipolar plate or current collector. In some types of fuel cells each bipolar plate is comprised of two separate plates that are attached together with a fluid passageway therebetween through which a coolant fluid flows to remove heat from both sides of the MEAs. In other types of fuel cells the bipolar plates include both single plates and attached together plates which are arranged in a repeating pattern with at least one surface of each MEA being cooled by a coolant fluid flowing through the two plate bipolar plates.

The fuel cells are operated in a manner that maintains the MEAs in a humidified state. The cathode and/or anode reactant gases being supplied to the fuel cell are typically humidified to prevent the drying of the MEAs in the locations proximate the inlets for the reactant gases. The level of humidity of the MEAs affects the performance of the fuel cell. Additionally, if an MEA is run too dry, the MEA can be damaged which can cause immediate failure or reduce the useful life of the fuel cell.

The operation of the fuel cells with the MEAs humidified too much (e.g., greater than 100%), however, limits the performance of the fuel cell stack. Specifically, the formation of liquid water impedes the diffusion of gas to the MEAs, thereby limiting their performance. The liquid water also acts as a flow blockage reducing cell flow and causing even higher fuel cell relative humidity which can lead to unstable fuel cell performance. Additionally, the formation of liquid water within the cell can cause significant damage when the fuel cell is shut down and is exposed to freezing conditions. That is, when the fuel cell is nonoperational and the temperature in the fuel cell drops below freezing, the liquid water therein will freeze and expand, potentially damaging the fuel cell.

Thus, it would be advantageous to control and operate the fuel cell in a manner that prevents and/or limits the formation of liquid water therein. It would be further advantageous if such a control or operation of the fuel cell resulted in the MEA being operated at a humidified state that results in optimum performance.

### SUMMARY OF THE INVENTION

The present invention provides operating strategies for a fuel cell system that controls the relative humidity (RH) of the membranes in the fuel cells and achieves a desired operational performance. The membrane hydration level is managed by controlling the relative humidity within the cathode flow path of the fuel cell stack and, in particular, the cathode gas flowing therethrough. The relative humidity of the cathode gas flowing through the cathode flow path is a function of the rate of water supplied by a humidification device, the rate of product water produced within the fuel cells, the rate at which the cathode gas is supplied, the pressure of the cathode gas, and the temperature of the cathode gas flowing in and exiting the cathode flow path. The temperature of the cathode gas is controlled by the coolant supply system. For a given RH set point for the cathode gas flowing into and exiting the cathode flow path, temperature set points for the cathode gas flowing into and exiting the cathode flow path are generated. The temperature set points are achieved by commanding the stack coolant control system to adjust the coolant flow to achieve the desired temperature set point. The rate at which the cathode gas is supplied may also be adjusted to mitigate temporary RH excursions that may occur during certain operational conditions, such as during a cold startup.

A method of operating a fuel cell system having a fuel cell stack with a plurality of fuel cells and a cathode flow path therethrough according to the principles of the present invention is disclosed. The method includes: (1) selecting a first target relative humidity for a fluid flow entering the cathode flow path; (2) selecting a second target relative humidity for the fluid flow exiting the cathode flow path; and (3) adjusting operating parameters of the fuel cell system to substantially achieve the first and second targeted relative humidities for the fluid flow respectively entering and exiting the cathode flow path.

In another aspect of the present invention, the method comprises: (1) selecting a first target relative humidity for a fluid flow entering the cathode flow path, the fluid flow having a known quantity of water vapor and a known temperature prior to entering the cathode flow path; (2) determining a first temperature of the fluid flow entering the cathode flow path that substantially achieves the first targeted relative humidity; (3) selecting a second target relative humidity for the fluid flow exiting the cathode flow path; (4) determining a second temperature of the fluid flow exiting the cathode flow path that substantially achieves the second targeted relative humidity based upon a molar fraction of water in the fluid flow exiting the cathode flow path; and (5) adjusting operating parameters of the coolant supply subsystem to substantially achieve the first and second temperatures for the fluid flow respectively entering and exiting the cathode flow path.

In still another aspect of the present invention, the method also includes adjusting a stoichiometric quantity of the fluid flow entering the cathode flow path to supplement the adjusting of operating parameters of the coolant supply system when adjusting operating parameters of the coolant supply system results in a response time to achieve the first and second temperatures greater than a predetermined value.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic representation of an exemplary mechanization for a fuel cell system with which the methods of the present invention can be employed;

FIG. 2 is a schematic representation of a control loop for the mechanization of FIG. 1 for controlling the coolant inlet temperature flowing into the fuel cell stack;

FIG. 3 is a schematic representation of a control loop for the mechanization of FIG. 1 for controlling the coolant temperature rise through the fuel cell stack; and

FIG. 4 is a flow chart illustrating the control method according to the principles of the present invention.

### DETAILED DESCRIPTION OF THE PREFERRED EMBODIMENT

The following description of the preferred embodiment is merely exemplary in nature and is in no way intended to limit the invention, its application, or uses. As used herein, the term “module” refers to an application specific integrated circuit (ASIC), an electronic circuit, a processor (shared, dedicated or group) and memory that execute one or more software or firmware programs, a combinational logic circuit, or other suitable components that provide the described functionality.

The present invention is directed to a method of controlling the operation of a fuel cell and/or fuel cell stack so that a desired state of hydration is achieved for the membranes in the fuel cell(s). In this regard, the present invention is discussed with reference to a specific mechanization for a fuel system having a fuel cell stack therein. It should be appreciated, however, that the mechanization shown is merely exemplary and that the methods of the present invention are applicable to other fuel cell systems having other mechanizations.

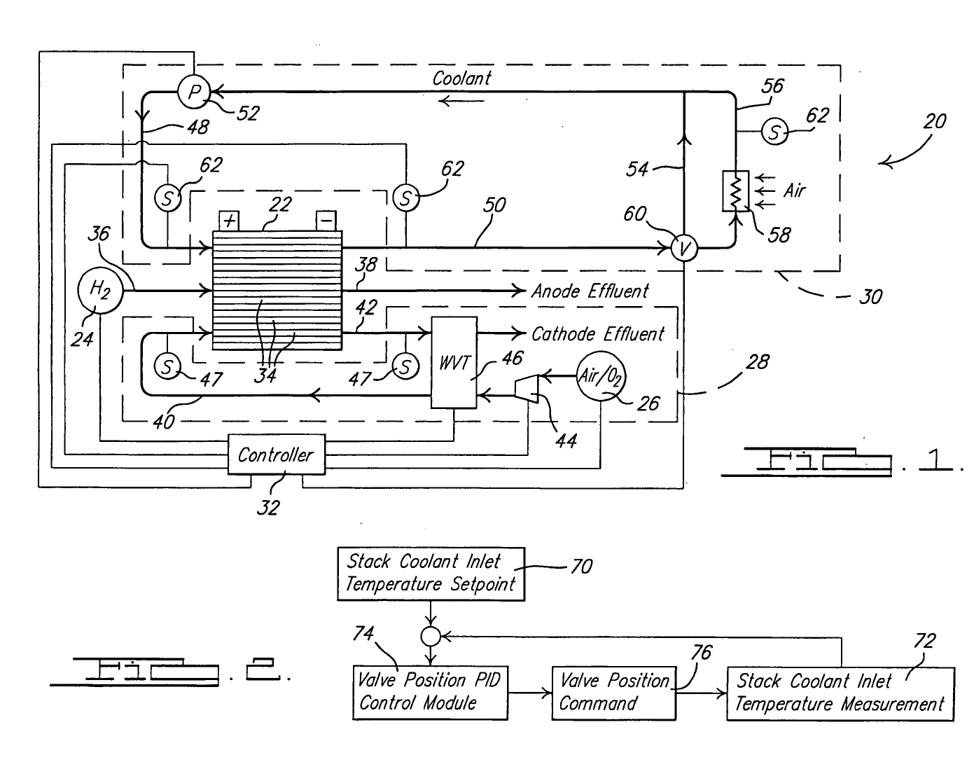

An exemplary fuel cell system 20 in which the methods of the present invention can be employed is schematically represented in FIG. 1. Fuel cell system 20 includes a fuel cell stack 22 which is connected to a hydrogen source 24 and an oxygen source 26, as are well known in the art. Oxygen source 26 is part of a cathode supply subsystem 28, described in more detail below. Fuel cell system 20 also includes a coolant supply subsystem 30 which supplies a coolant flow through fuel cell stack 22. A controller 32 is operable to control the operation of fuel cell system 20 and the components therein.

Fuel cell stack 22 includes a plurality of fuel cells 34 arranged in a stacked configuration. Fuel cells 34 include a plurality of membrane electrode assemblies (MEAs) each disposed between a plurality of bipolar plates. As is known in the art, the stack may also include a plurality of gas distribution layers, a plurality of anode manifolds, a plurality of cathode manifolds, a plurality of coolant manifolds and end plates, all arranged in a stacked relation. The sequence of MEAs and bipolar plates is repeated to provide the desired voltage output for fuel cell stack 22. As is known in the art, each MEA includes a membrane in the form of a thin proton transmissive non-electrically conductive solid polymer electrolyte. An anode catalyst layer is provided on one surface of the membranes and a cathode catalyst layer is provided on the opposite surface of the membranes. For purposes of the present invention, the configuration of fuel cell stack 22 can be of any known arrangement. Fuel cell stack 22 has an anode flow path through which the anode reactant gas flows, a cathode flow path through which the cathode reactant gas flows and a coolant flow path through which the coolant flows. As used herein, the terms “inlet” and “outlet” refer to the inlet and outlet of the respective flow paths within fuel cell stack 22.

Hydrogen source 24 can include a fuel processor or stored hydrogen, as is known in the art. Hydrogen source 24 supplies a flow of anode reactant to the anode flow path in fuel cell stack 22 via anode supply plumbing 36. Anode effluent is exhausted from the anode flow path of fuel cell stack 22 via anode exhaust plumbing 38. Controller 32 communicates with hydrogen source 24 and the various valves and actuators (not shown) within the anode supply subsystem to control and coordinate the flow of anode reactant into the anode flow path and the removal of anode effluent from the anode flow path. Operation of the anode supply subsystem will not be described further. It should be appreciated, however, that anode reactant will be supplied to the anode flow path in quantities sufficient to meet the power demand placed on fuel cell stack 22 and anode effluent will be removed from the anode flow path, as needed, to achieve a desired operating condition.

Cathode reactant is supplied to the cathode flow path of fuel cell stack 22 from oxygen source 26 via cathode supply plumbing 40. The cathode reactant can be ambient air or air/O₂ from a storage tank. Cathode effluent is exhausted from the cathode flow path of fuel cell stack 22 via cathode exhaust plumbing 42. The cathode reactant gas is supplied to fuel cell stack 22 by a compressor 44. The cathode reactant gas flows from compressor 44 through a humidifying device 46, in this case in the form of a water vapor transfer (WVT) device wherein the cathode reactant gas is humidified. The cathode reactant gas then flows through the cathode flow path in fuel cells 34 of fuel cell stack 22 and exits fuel cell stack 22 in the form of cathode effluent via cathode exhaust plumbing 42. The cathode effluent is routed through WVT device 46. As used herein, the term “cathode gas” may refer to both the cathode reactant and the cathode effluent.

Within WVT device 46, water vapor from the cathode effluent stream is transferred to the cathode reactant stream being supplied to fuel cell stack 22. The operation of WVT device 46 can be adjusted to provide differing levels of water vapor transfer between the cathode effluent stream and the cathode reactant stream. Additionally, a bypass loop (not shown) can be employed to allow some cathode reactant to bypass WVT device 46 and allow additional control of the relative humidity of the cathode reactant downstream of WVT device 46.

Cathode supply subsystem 28 also includes various sensors 47 which measure various operating parameters of cathode supply subsystem 28. Sensors 47 may include temperature sensors, pressure sensors, flow rate sensors, humidity sensors, and the like, as needed, to monitor and control the operation of cathode supply subsystem 28.

Controller 32 controls the operation of cathode supply subsystem 28. Controller 32 communicates with compressor 44, WVT device 46, and sensors 47 to control the supplying and humidification of the cathode reactant and the removal of cathode effluent from the cathode flow path.

Coolant supply subsystem 30 supplies a coolant stream to the coolant flow path within fuel cell stack 22 via coolant supply plumbing 48 and removes coolant from the coolant flow path within fuel cell stack 22 via coolant exit plumbing 50. A pump 52 is operable to cause the coolant stream to flow throughout coolant supply plumbing 48, the coolant flow path within fuel cell stack 22, and coolant exit plumbing 50. The coolant stream exiting fuel cell stack 22 flows back to pump 52 through either a bypass loop 54 or a radiator loop 56 having an air-cooled radiator 58 therein. A bypass valve 60 is operable to route the entire coolant stream or a portion thereof through either bypass loop 54 or radiator loop 56 prior to flowing back to pump 52 for recirculation through fuel cell stack 22. Coolant supply subsystem 30 also includes a plurality of sensors 62 that measure various operating parameters of coolant supply subsystem 30, such as temperatures, flow rates and pressures.

Sensors 62 communicate with the controller 32 to enable controller 32 to control and coordinate the operation of coolant supply subsystem 30 to obtain a desired temperature for the coolant flowing into and out of the coolant flow path. Controller 32 communicates with pump 52 and bypass valve 60 to control the speed of pump 52 and the position of bypass valve 60. By adjusting the speed of pump 52 and the position of bypass valve 60, the inlet and outlet temperatures for the coolant flowing through the coolant flow path of fuel cell stack 22 can be controlled.

Coolant supply subsystem 30 extracts heat from fuel cell stack 22 and transfers that heat to the ambient via radiator 58. The rate of heat transfer from fuel cell stack 22 to the coolant is:

$${Q}_{stack} = \frac{ⅆ m}{ⅆ t} {c}_{p} Δ t \qquad ( 1 )$$

where:

Q_{stack}=rate of heat transfer from the fuel cell stack to the coolant;

$$\frac{ⅆ m}{ⅆ t} = coolant flow rate ;$$

cₚ=heat capacity of the coolant; and

Δt=difference in coolant temperature entering stack and coolant temperature leaving stack.

Similarly, the rate at which waste heat in the coolant is transferred from radiator 58 to the ambient air is:

$${Q}_{ra d} = \frac{ⅆ m}{ⅆ t} {c}_{p} Δ t \qquad ( 2 )$$

where:

Q_{rad}=rate of heat transfer from the radiator to the ambient air; and

Δt=difference in coolant temperature entering radiator and coolant temperature leaving radiator.

The coolant inlet (to the coolant flow path) temperature is controlled by adjusting the position of bypass valve 60, so that the blend of coolant flowing through bypass loop 54 and radiator loop 56 mixes to a desired temperature set point. The blended coolant is pumped into the inlet to the coolant flow path in fuel cell stack 22. The coolant inlet temperature (Tₛᵢ) as a function of valve position (Vp), radiator coolant out temperature (Tᵣₒ), and stack coolant outlet temperature (Tₛₒ), is:
Tₛᵢ=TₛₒVₚ+Tᵣₒ(1−Vp)

The coolant temperature exiting fuel cell stack 22 is controlled by adjusting the speed (PS) of coolant pump 52 so that the coolant flow rate

$$( \frac{ⅆ m}{ⅆ t} )$$

results in the desired temperature rise. The coolant outlet temperature (Tₛₒ) as a function of coolant flow rate

$$( \frac{ⅆ m}{ⅆ t} ) ,$$

the coolant inlet temperature (Tₛᵢ) flowing into the coolant flow path, and stack waste heat (Q_{stack}) is:

$${T}_{so} = {T}_{si} + \frac{{Q}_{stack}}{\frac{ⅆ m}{ⅆ t} {c}_{p}}$$

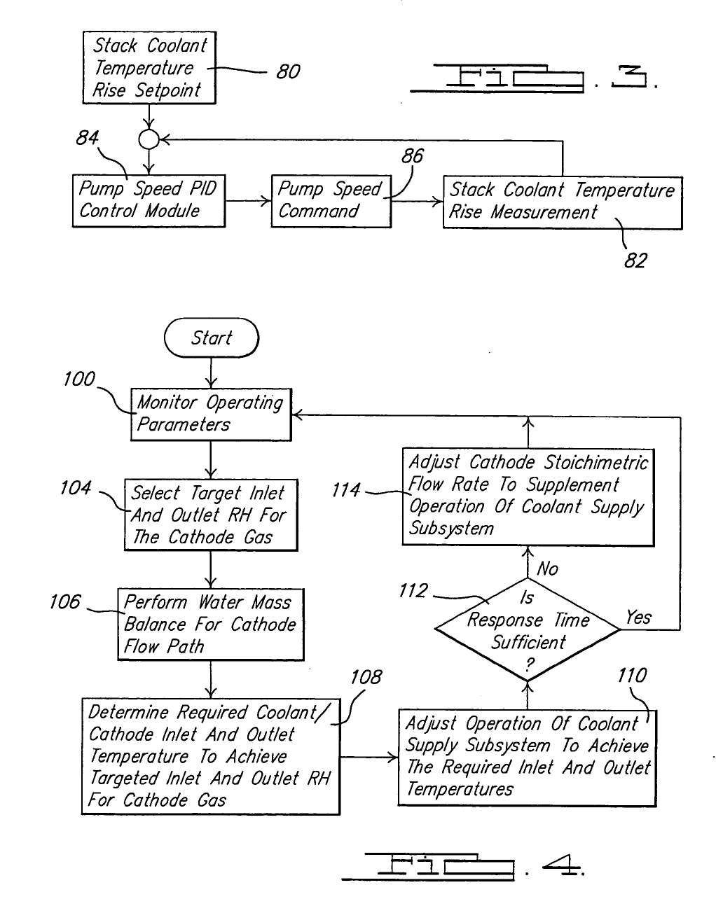

Based on these heat flow models for coolant supply subsystem 30, a number of control scenarios can be utilized to control both the inlet and outlet temperatures of the coolant flowing in and out of the coolant flow path. One simple method is illustrated in FIGS. 2 and 3. In FIG. 2 a PID radiator bypass valve control module is utilized while in FIG. 3 a PID coolant pump control module is utilized.

The control scheme illustrated in FIG. 2 can be used to control the coolant inlet temperature flowing into the coolant flow path of fuel cell stack 22. A comparison of a stack coolant inlet temperature set point, as indicated in block 70, to the actual temperature of the coolant flowing into the coolant flow path, as indicated in block 72, is sent to the valve position PID control module of controller 32, as indicated in block 74. Based on the comparison, bypass valve 60 is commanded to take a desired position that causes the stack coolant inlet temperature to approach and/or match the set point temperature, as indicated in block 76. The stack coolant inlet temperature is again measured, as indicated in block 72 and compared to the stack coolant inlet temperature set point, as indicated in block 70, for further adjustments to the valve position as dictated by the comparison. Thus, a feedback control loop can be utilized to adjust the position of bypass valve 60 to achieve a desired coolant temperature flowing into the coolant flow path of fuel cell stack 22.

FIG. 3 shows a feedback control loop that can be utilized to control the temperature rise of the coolant as it flows through the coolant flow path within fuel cell stack 22. In this feedback control loop, a stack coolant temperature rise set point, as indicated in block 80, is compared to a stack coolant temperature rise measurement, as indicated in block 82, is sent to pump speed PID control module of controller 32, as indicated in block 84. Based on the comparison, a desired pump speed is commanded to pump 52 that causes the stack coolant temperature rise to approach and/or match the set point value. The stack coolant temperature rise is again measured, as indicated in block 82, and compared to the stack coolant temperature rise set point, as indicated in block 80, for further adjustments to the pump speed as dictated by the comparison. Thus, a feedback control loop can be utilized to adjust the speed of pump 52 to achieve a desired stack coolant temperature rise across the coolant flow path of fuel cell stack 22.

It should be appreciated that while controller 32 is shown schematically in FIG. 1 as being a single controller, controller 32 can include multiple discreet controllers and/or modules that each have assigned responsibilities or functional capabilities to control various aspects of fuel cell system 20.

Controller 32 monitors various operating parameters of fuel cell system 20 and adjusts these operating parameters to achieve the desired state of hydration. Controller 32 commands, as needed, the various components of fuel cell system 20 to operate in the manner that causes the cathode gas within the cathode flow path to match a targeted inlet and outlet relative humidity so that the desired state of hydration of the membranes is achieved.

The present invention provides for controlling the relative humidity of the cathode gas flowing in and out of the cathode flow path to maintain the state of hydration of the membrane within a specified range. The method uses a relative humidity set point for the cathode gas flowing into and out of the cathode flow path that results in a desired membrane hydration level. Based on these relative humidity set points, the water vapor in the cathode gas prior to entering the cathode flow path, the product water generated in the cathode flow path, and the cathode gas pressure, the required inlet and outlet temperatures of the cathode gas to achieve those relative humidity set points are established. The inlet and outlet temperatures for the cathode gas are used to determine the appropriate coolant temperatures entering and exiting the coolant flow path. As stated above, the coolant and cathode gas temperatures are substantially the same as each other throughout their respective flow paths. Accordingly, the temperatures for the cathode gas that provide the desired relative humidity levels are the same for the coolant entering and exiting the coolant flow path.

Referring to FIG. 4, the method of controlling the state of hydration of the membranes within fuel cells 34 of fuel cell stack 22 is illustrated. Controller 32 monitors the various operating parameters of fuel cell stack 22 and fuel cell system 20, as indicated in block 100. Based on the operating parameters, a targeted inlet and outlet relative humidity (RH) for the cathode gas is selected, as indicated in block 104. The inlet and outlet relative humidities for the cathode gas are selected to provide a desired state of hydration for the membrane.

Based on the targeted inlet and outlet relative humidity for the cathode gas, required coolant/cathode gas inlet and outlet temperatures are determined in order to achieve the targeted inlet and outlet relative humidity for the cathode gas. The required temperature is based upon the water content of the cathode gas flowing into the cathode flow path and the water vapor content of the cathode gas exiting the cathode flow path. The water vapor content of the cathode gas flowing into the cathode flow path is determined based upon the operation of WVT device 46 while the water vapor content of the cathode gas exiting the cathode flow path is based upon performing a water mass balance for the cathode flow path, as described below.

The relative humidity of the cathode gas can be determined using the following equation:

$$RH = \frac{[ {H}_{2} O ] * {P}_{tot}}{{P}_{sat}} \qquad ( 3 )$$

where:

[H₂O]=molar fraction of water in the gas;

Pₜₒₜ=pressure of the gas; and

Pₛₐₜ=saturation pressure of the gas.

Pₛₐₜ can be determined either empirically or using Antoine's Equation.

Empirically, Pₛₐₜ can be determined as:
Pₛₐₜ=9.7022*10⁻⁷*T⁴−3.5021*10⁻⁵*T⁻³+3.7283*10⁻³*T²+1.231*10⁻²*T+0.70996 (4)

where T is the gas temperature in ° C.

Using Antoine's Equation, Pₛₐₜ can be determined as:

$${log}_{10} {P}_{sat} = A - \frac{B}{T + C} \qquad ( 5 )$$

The empirical form is good for avoiding divide-by-zero errors while Antoine's Equation is good for solving for T.

To determine the required outlet temperature to achieve the targeted outlet RH, a water mass balance for the cathode flow path is performed, as indicated in block 106. The water mass balance takes into account the water flow rate into the cathode flow path, the rate of product water generation within the cathode flow path, and the water flow rate out of the cathode flow path. The water within the cathode flow path that flows from the cathode flow path to the anode flow path due to partial pressures and the diffusivity of the membrane is small enough to ignore for purposes of this control strategy. If desired, however, the water mass balance could take into account the water flowing from the cathode flow path into the anode flow path. This calculation, however, would be more complicated.

The first step in performing the water mass balance is to determine the molar flow rate of water into the cathode flow path. The molar flow fraction of water in the cathode gas is:

$$[ {H}_{2} O ] = \frac{{n}_{{H}_{2} O}}{{n}_{{H}_{2} O} + {n}_{gas}} \qquad ( 6 )$$

where:

n_{H}_{₂}_{O}=molar flow rate of water; and

n_{gas}=molar flow rate of the cathode gas.

The molar flow rate of cathode gas can be determined by the equation:

$${n}_{gas} = \frac{cathode gas flow rate}{molecular weight ( MW ) of the cathode gas} \qquad ( 7 )$$

Using equations (3) and (6) and rearranging, the molar flow rate of water flowing into the cathode flow path can be determined as:

$${n}_{{H}_{2} {O}_{\_in}} = ( \frac{{RH}_{i n} * {P}_{sat\_in}}{{P}_{tot\_in} - {RH}_{i n} * {P}_{sat\_in}} ) * {n}_{gas} \qquad ( 8 )$$

Next, the rate at which product water is made is determined as:

$$\begin{matrix}{n}_{{H}_{2} {O}_{\_made}} = \frac{{e}^{-} \frac{ⅆ n}{ⅆ t}}{2} \\ and & ( 9 ) \\ {e}^{-} \frac{ⅆ n}{ⅆ t} = \frac{I * \# cells}{Na * Q} & ( 10 )\end{matrix}$$

where:

I=current being produced (amps);

# cells=number of fuel cells;

Na=Avagodro's number; and

Q=electron charge (Columb/electron).

Substituting equation 10 into equation 9 yields:

$${n}_{{H}_{2} {O}_{\_made}} = \frac{( \frac{I * \# cells}{Na * Q} )}{2} \qquad ( 11 )$$

Using the results of equation (8) (molar flow rate of water flowing into the cathode flow path) and the results of equation (11) (molar rate of water produced in the cathode flow path), the total water leaving the cathode flow path (ignoring any water transferred from the cathode flow path to the anode flow path and assuming all water is being removed), is determined as:
n_{H}_{₂}_{O}_{ₒᵤₜ}=n_{H}_{₂}_{O}_{ᵢₙ}+n_{H}_{₂}_{O}_{_{made}} (12)

The molar flow rate of the cathode gas flowing out of the cathode flow path is:
n_{gas—out}=n_{gas—in}−n_{O}_{_{2—consumed}} (13)

when the cathode gas is air:
n_{gas—in}=n_{O}_{₂}ᵢₙ+n_{N}_{₂}ᵢₙ (14a)

when the cathode gas is oxygen:
n_{gas—in}=n_{O}_{₂}ᵢₙ (14b)

n_{gas—in} can be determined using equation (7).

n_{O}_{₂}_{consumed} is determined as:

$${n}_{{O}_{2} consumed} = \frac{{e}^{-} \frac{ⅆ n}{ⅆ t}}{4} \qquad ( 15 )$$

Substituting into equation (13) yields:

when the cathode gas is air:
n_{gas—out}n_{O}_{_{2—in}}n_{O}_{_{2—consumed}}+n_{N}_{₂} ᵢₙ (16a)

when the cathode gas is oxygen:
n_{gas—out}=n_{O}_{₂}ᵢₙ−n_{O}_{_{2—consumed}} (16b)

The molar fraction of water at the cathode flow path outlet ([H₂O]_{—out}) can now be determined using equation (6). The saturation pressure of the cathode gas exiting the cathode flow path (P_{sat—out}) can be determined using equation (4). The relative humidity of the cathode gas exiting the cathode flow path (RH_{—out}) can then be determined using equation (3).

With this knowledge, the required cathode inlet and outlet temperatures to achieve the targeted inlet and outlet relative humidities for the cathode gas are determined, as indicated in block 108. To determine the required inlet (T_{reg—in}) and outlet (T_{req—out}) cathode gas temperatures, equation (5) is rearranged to solve for T and equation (3) is rearranged and substituted for Pₛₐₜ in equation (5) and yields:

$$T = \frac{B}{A - {log}_{10} \frac{[ {H}_{2} O ] * {P}_{tot}}{RH}} - C \qquad ( 17 )$$

Using equation (17) and the values for these various parameters at the appropriate location, the required temperature for the cathode gas flowing into and out of the cathode flow path to achieve the targeted inlet and outlet relative humidities for the cathode gas are computed.

Operation of the coolant supply subsystem 30 is adjusted to cause the cathode reactant gas to achieve the required inlet and outlet temperatures, as indicated in block 110. The adjustment of coolant supply subsystem 30 is done as discussed above with reference to equations (1) and (2) and the control strategies illustrated in FIGS. 2 and 3.

### EXAMPLE

The following example illustrates performing a water mass balance for the cathode flow path and determining the required cathode inlet and outlet temperatures to achieve the targeted inlet and outlet relative humidities for the cathode gas as called for in blocks 106 and 108. In the example, the coolant is in a co-flow arrangement with the cathode gas while the anode gas is in a counter-flow arrangement with the cathode gas. The values for the various operating parameters are shown in Table I.

TABLE I

| Flow Arrangement | Coolant = co-flow |
|---|---|
| | Anode = counter flow |
| Cathode Gas | Air |
| Tₒᵤₜ | 70.58° C. |
| Pₒᵤₜ | 110 KPa (825.1 mm Hg) |
| I | 450 Amps |
| # cells | 100 |
| Cathode Stoichiometry | 2.0 |
| Air flow | 32.3 g/s |
| WVT RHₒᵤₜ | 40% |
| WVT Tₒᵤₜ | 70.58° C. |
| Pᵢₙ | 130 KPa (975.1 mm Hg) |
| Target RHᵢₙ | 50% |
| Target RHₒᵤₜ | 90% |

To perform the water mass balance, the molar flow rate of water into the cathode flow path is determined. The molar flow rate of the cathode gas using equation (7) is:

$${n}_{gas\_in} = \frac{32.3 g \text{/} s}{28.85 g \text{/} mol} = 1.1196 \frac{mol}{s}$$

P_{sat—in} is solved empirically using equation (4):
P_{sat—in} (70.58 deg C.)=31.96 KPa

The molar flow rate of water in the cathode gas exiting the WVT device and flowing into the cathode flow path using equation (8) is:

$${n}_{{H}_{2} O\_in} = \frac{0.4 * 31.96 KPa}{130 KPa - 0.4 * 31.96 KPa} * 1.1196 \frac{mol}{s} = 0.1219 \frac{mol}{s}$$

Water made in the cathode flow path using equation (11) is:

$${n}_{{H}_{2} O\_made} = \frac{( \frac{450 amps * 100 cells}{6.022 * {10}^{23} \frac{molecules}{mol} * 1.6022 * {10}^{- 19} Colombs} )}{2} = 0.2332 \frac{mol}{s}$$

The total water leaving the cathode flow path using equation (12) is:

$${n}_{{H}_{2} O\_out} = 0.1219 \frac{mol}{s} + 0.2332 \frac{mol}{s} = 0.3551 \frac{mol}{s}$$

To determine the molar flow rate of gas flowing out of the cathode flow path, equation (16a) will be used. First, the n_{gas—in} using equation (7) is determined:

$${n}_{gas\_in} = \frac{32.3 g \text{/} s}{28.85 g \text{/} mol} = 1.1196 \frac{mol}{s}$$

Breaking n_{gas—in} into its nitrogen and oxygen components yields:

$${n}_{{N}_{2 \_in}} = {n}_{gas\_in} * 0.79 = 1.1196 \frac{mol}{s} * 0.79 = 0.8845 \frac{mol}{s}$$

$${n}_{{O}_{2 \_in}} = {n}_{gas\_in} * 0.21 = 1.1196 \frac{mol}{s} * 0.21 = 0.2351 \frac{mol}{s}$$

The oxygen consumed in the cathode flow path using equations (10) and (15) is:

$${n}_{{O}_{2 \_consumed}} = \frac{{e}^{-} \frac{ⅆ n}{ⅆ t}}{4} = \frac{\frac{I * \# cells}{Na * Q}}{4} = \frac{0.4664 \frac{mol}{s}}{4} = 0.1196 \frac{mol}{s}$$

Now using equation (16a) n_{gas—out} is determined:

$${n}_{gas\_out} = {n}_{{O}_{2} \_in} - {n}_{{O}_{2} \_consumed} + {n}_{{N}_{2 \_in}} = 0.2351 \frac{mol}{s} - 0.1166 \frac{mol}{s} + 0.8845 \frac{mol}{s} = 1.0011 \frac{mol}{s}$$

The molar fraction of water at the cathode outlet using equation (6) is:

$${[ {H}_{2} O ]}_{out} = \frac{{n}_{{H}_{2} O\_out}}{{n}_{{H}_{2} O\_out} + {n}_{gas\_out}} = \frac{0.3551 \frac{mol}{s}}{0.3551 \frac{mol}{s} + 1.0011 \frac{mol}{s}} = 26.18 \%$$

P_{sat—out} at the outlet temperature of 70.58° C. using the empirical formula in equation (4) is:
P_{sat—out}(70.58 deg C.)=31.96 KPa

RHₒᵤₜ using equation (3) is:

$${RH}_{out} = \frac{{[ {H}_{2} O ]}_{out} * {P}_{tot\_out}}{{P}_{sat\_out}} = \frac{0.2618 * 110 KPa}{31.96 KPa} = 90.12 \%$$

The targeted outlet relative humidity (RH_{target—out}) of the cathode gas is 90%. Using the target value and equation (17), the required cathode outlet temperature (T_{req—out}) to achieve the targeted outlet relative humidity for the cathode gas is:

$$\begin{matrix}{T}_{req\_out} = \frac{B}{A - {log}_{10} * \frac{{[ {H}_{2} O ]}_{out} * {P}_{tot\_out}}{{RH}_{target\_out}}} - C \\ = \frac{1668.21}{7.96681 - {log}_{10} * \frac{0.2618 * 825.1 mm Hg}{0.9}} - 228 \\ = 70.61 ° C .\end{matrix}$$

Thus, the required outlet temperature for the cathode gas is 70.61° C. to achieve a 90% relative humidity exiting the cathode flow path. To determine the required cathode inlet temperature (T_{req—in}) to achieve the targeted inlet relative humidity (RH_{target—in}) which is 50%, the molar fraction of water in the cathode gas exiting the WVT device using rearranged equation (3) is determined first as:

$${[ {H}_{2} O ]}_{i n} = \frac{{RH}_{i n} * {P}_{sat\_in}}{{P}_{tot\_in}} = \frac{0.4 * 31.96 KPa}{130 KPa} = 9.834 \%$$

The targeted inlet relative humidity (RH_{target—in}) of the cathode gas is 50%. Using the target value and equation (17), the required cathode inlet temperature (T_{req—in}) to achieve the targeted inlet relative humidity for the cathode gas is:

$$\begin{matrix}{T}_{req\_in} = \frac{B}{A - {log}_{10} * \frac{{[ {H}_{2} O ]}_{i n} * {P}_{tot\_in}}{{RH}_{target\_in}}} - C \\ = \frac{1668.21}{7.96681 - {log}_{10} * \frac{0.098338 * 975.1 mm Hg}{0.5}} - 228 \\ = 65.46 ° C .\end{matrix}$$

Thus, to achieve the targeted inlet and outlet relative humidities for the cathode gas, the inlet temperature should be 65.46° C. and the outlet temperature should be 70.61° C. With the coolant and cathode gas being co-flow, the coolant and cathode gas temperatures are substantially the same throughout their respective flow paths. The coolant supply subsystem 30 will be commanded to have a coolant inlet temperature set point of 65.46° C. and a coolant outlet temperature set point of 70.61° C. which yields a coolant temperature rise set point of 5.15° C.

Referring back to FIG. 4, after the adjustment of operation of the coolant subsystem to achieve the required inlet/outlet temperatures, a decision is made as to whether the response time to achieve the required inlet/outlet temperatures is sufficient, as indicated in device block 112. Under certain circumstances, the response time of the coolant supply subsystem may be inadequate causing the relative humidities of the cathode gas to be too low or too high for a period of time and result in an undesirable operating condition. For example, during a cold system start or extreme transients there may not be enough heat generated in the fuel cell stack to account for the conductive losses or too much heat to quickly remove. When this is the case, the coolant supply subsystem may be in an uncontrolled region wherein the bypass valve is saturated (fully open or closed) and/or the pump speed is saturated (at its highest or lowest setting) and the response time to achieve the temperature set points for the coolant (cathode gas) is beyond an acceptable time period.

If the response time is sufficient, no further action is necessary and the control process starts again, as indicated in decision block 112, with the monitoring of the operating parameters, as indicated in block 100, and preceeding back to decision block 112. If the response time is insufficient, however, as indicated by decision block 112, the cathode stoichiometric flow rate to the cathode flow path can be adjusted to supplement operation of coolant supply subsystem, as indicated in block 114. By adjusting the stoichiometric flow rate of the cathode gas, the relative humidity can be altered to maintain the state of hydration of the membranes in a desired range and/or minimize the excursions outside of the acceptable ranges for the state of hydration of the membranes. For example, one idle condition may be:

TABLE 2

| I | 10 amps |
|---|---|
| Coolant Tₒᵤₜ | 64.6deg C. |
| Coolant Tᵢₙ | 62.5deg C. |
| Cath stoichiometry | 2.5 |
| Cath out RH | 95% |

Where the low temperature is desired for stack durability reasons.

On a power up transient, the coolant in and out (cathode in and out) temperatures will remain low for a short period of time, resulting in an instantaneous error in the RH and the following operating conditions to be present:

TABLE 3

| I | 450 amps |
|---|---|
| Coolant Tₒᵤₜ | 64.6deg C. |
| Coolant Tᵢₙ | 62.5deg C. |
| Cath stoichiometry | 1.6 |
| Cath out RH | 132% |

The excessively high outlet relative humidity will result in two phase flow that may lead to stability and other problems for the fuel cell system. The relative humidity can be quickly brought back to within a desired range by raising the cathode flow and result in the following operating conditions to occur:

TABLE 4

| I | 450 amps |
|---|---|
| Coolant Tₒᵤₜ | 64.6deg C. |
| Coolant Tᵢₙ | 62.5deg C. |
| Cath stoichiometry | 2.2 |
| Cath out RH | 108% |

The 108% outlet relative humidity may be acceptable for the few seconds it takes for coolant supply subsystem 30 to adjust the temperatures of the coolant flow to meet the required cathode inlet and outlet temperatures to achieve the targeted inlet and outlet relative humidities for the cathode gas. Thus, the cathode stoichiometric flow rate can be adjusted to supplement the operation of the coolant supply subsystem when the response time is insufficient. Once the cathode stoichiometric flow rate has been adjusted, the control process starts again at block 100 and proceeds through the control strategy to decision block 112.

Accordingly, during the operation of fuel cell system 20, the membrane hydration level can be managed by controlling the cathode gas relative humidity. The cathode gas relative humidity is a function of the rate of water supplied by a cathode inlet humidification device, the product water from the fuel cell electrochemical reaction, the cathode gas supply rate, the pressure in the cathode flow path, and stack coolant inlet/outlet temperature. For a target relative humidity set point, a temperature set point is generated. The temperature set point is commanded to the coolant supply subsystem to achieve the required temperatures. Additionally, the air supply may also be adjusted to supplement the response time of the coolant supply subsystem and mitigate any temporary relative humidity excursions.

The description of the invention is merely exemplary in nature and variations that do not depart from the gist of the invention are intended to be within the scope of the invention. For example, the present invention is applicable to fuel cell stacks wherein the arrangements of the coolant flow, cathode flow and anode flow differ from those illustrated in the specific example. The coolant supply subsystem 30 illustrated herein is merely exemplary of one possible coolant supply subsystem and it should be appreciated that other coolant supply subsystems can be employed. Furthermore, the control strategy implemented with the coolant supply subsystem to achieve the desired temperatures is one example for the particular configuration shown. The specific control strategy for the coolant supply subsystem will vary based upon the design (mechanization) and the capabilities of the components therein. Moreover, the mechanization of cathode supply subsystem 28 is merely exemplary and it should be appreciated that other mechanizations can be employed. For example, other types of humidification devices other than WVT device can be utilized. Furthermore, the mechanization of fuel cell system 20 shown in FIG. 1 is merely one possible mechanization. The strategy of the present invention can be applied to other mechanizations for a fuel cell system. For example, a heat exchanger can be utilized in both the cathode and coolant inlet plumbing to allow the cathode gas and coolant to achieve a substantially same temperature prior to entering their respective flow paths in the fuel cell stack. Additionally, fuel cell stack 22 could be segregated into multiple fuel cell stacks with separate flow paths for each of the stacks and, possibly, some cross feeding of fluid streams therebetween. Finally, additional sensors may be employed throughout the fuel cell system, as needed, to monitor the necessary operating parameters to practice the present invention. Thus, such variations are not to be regarded as a departure from the spirit and scope of the invention.

What is claimed is:

1. A method of operating a fuel cell system having a fuel cell stack with a plurality of fuel cells and a cathode flow path therethrough, the method comprising:
(a) selecting a first target relative humidity for a fluid flow entering the cathode flow path;
(b) selecting a second target relative humidity for said fluid flow exiting the cathode flow path; and
(c) adjusting operating parameters of the fuel cell system to substantially achieve said first and second targeted relative humidities for said fluid flow respectively entering and exiting the cathode flow path.

2. The method of claim 1, further comprising:
determining a first temperature of said fluid flow entering the cathode flow path that achieves said first targeted relative humidity; and
determining a second temperature of said fluid flow exiting the cathode flow path that achieves said second targeted relative humidity,
wherein (c) includes adjusting operating parameters of the fuel cell system to substantially achieve said first and second temperatures for said fluid flow respectively entering and exiting the cathode flow path.

3. The method of claim 2, wherein the fuel cell system includes a coolant supply system and (c) includes adjusting operating parameters of the coolant supply system to substantially achieve said first and second temperatures for said fluid flow respectively entering and exiting the cathode flow path.

4. The method of claim 3, wherein (c) includes adjusting at least one of a flow rate of a coolant fluid flowing through the fuel cell stack and a coolant bypass valve that selectively allows a portion of said coolant fluid exiting the fuel cell stack to bypass a heat removal element prior to flowing back into the fuel cell stack.

5. The method of claim 3, wherein (c) includes adjusting a stoichiometric quantity of said fluid flow entering the cathode flow path to supplement said adjusting of operating parameters of the coolant supply system when adjusting operating parameters of the coolant supply system results in a response time to achieve said first and second temperatures greater than a predetermined value.

6. The method of claim 2, wherein determining said second temperature is based upon a molar fraction of water in said fluid flow exiting the cathode flow path.

7. The method of claim 6, wherein determining said second temperature includes determining said molar fraction of water in said fluid flow exiting the cathode flow path by performing a mass balance for the cathode flow path.

8. The method of claim 6, wherein determining said second temperature is based upon said molar fraction of water and a pressure of said fluid flow exiting the cathode flow path.

9. The method of claim 2, wherein determining said first temperature is based upon a quantity of water vapor in said fluid flow prior to entering the cathode flow path.

10. The method of claim 9, wherein determining said first temperature is based upon a quantity of water vapor in said fluid flow exiting a humidifying device prior to entering the cathode flow path.

11. A method of operating a fuel cell system having a coolant supply subsystem and fuel cell stack with cathode and coolant flow paths therethrough, the method comprising:
(a) selecting a first target relative humidity for a fluid flow entering the cathode flow path, said fluid flow having a known quantity of water vapor and a known temperature prior to entering the cathode flow path;
(b) determining a first temperature of said fluid flow entering the cathode flow path that substantially achieves said first targeted relative humidity;
(c) selecting a second target relative humidity for said fluid flow exiting the cathode flow path;
(d) determining a second temperature of said fluid flow exiting the cathode flow path that substantially achieves said second targeted relative humidity based upon a molar fraction of water in said fluid flow exiting the cathode flow path; and
(e) adjusting operating parameters of the coolant supply subsystem to substantially achieve said first and second temperatures for said fluid flow respectively entering and exiting the cathode flow path.

12. The method of claim 11, wherein (e) includes adjusting at least one of a flow rate of a coolant fluid flowing through the coolant flow path and a coolant bypass valve that selectively allows a portion of said coolant fluid exiting the coolant flow path to bypass a heat removal element prior to flowing back into the coolant flow path.

13. The method of claim 11, further comprising establishing a known quantity of water vapor in said fluid flow with a humidifying device prior to said fluid flow entering the cathode flow path and wherein (b) includes determining said first temperature based upon said known quantity of water vapor in said fluid flow exiting said humidifying device.

14. The method of claim 11, wherein (d) includes determining said molar fraction of water in said fluid flow exiting the cathode flow path by performing a mass balance for the cathode flow path.

15. The method of claim 11, wherein (d) includes determining said second temperature is based upon said molar fraction of water and a pressure of said fluid flow exiting the cathode flow path.

16. The method of claim 11, wherein (e) includes adjusting a stoichiometric quantity of said fluid flow entering the cathode flow path to supplement said adjusting of operating parameters of the coolant supply subsystem when adjusting operating parameters of the coolant supply subsystem results in a response time to achieve said first and second temperatures greater than a predetermined value.

17. A method of operating a fuel cell stack having a plurality of fuel cells and cathode and coolant flow paths therethrough, the method comprising:
(a) selecting a first target relative humidity for a fluid flow entering the cathode flow path, said fluid flow having a known quantity of water vapor and a known temperature prior to entering the cathode flow path;
(b) determining a first temperature of said fluid flow entering the cathode flow path that substantially achieves said first targeted relative humidity;
(c) selecting a second target relative humidity for said fluid flow exiting the cathode flow path;
(d) determining a second temperature of said fluid flow exiting the cathode flow path that substantially achieves said second targeted relative humidity based upon a molar fraction of water in said fluid flow exiting the cathode flow path;
(e) adjusting operating parameters of a coolant supply system to substantially achieve said first and second temperatures, said coolant supply system supplying a coolant flow to the coolant flow path; and
(f) adjusting a stoichiometric quantity of said fluid flow entering the cathode flow path to supplement said adjusting of operating parameters of said coolant supply system when adjusting operating parameters of said coolant supply system results in a response time to achieve said first and second temperatures greater than a predetermined value.

18. The method of claim 17, wherein (e) includes adjusting at least one of a flow rate of a coolant fluid flowing through the coolant flow path and a coolant bypass valve that selectively allows a portion of said coolant fluid exiting the coolant flow path to bypass a heat removal element prior to flowing back into the coolant flow path.

19. The method of claim 17, further comprising establishing a known quantity of water vapor in said fluid flow with a humidifying device prior to said fluid flow entering the cathode flow path and wherein (b) includes determining said first temperature based upon said known quantity of water vapor in said fluid flow exiting said humidifying device.

20. The method of claim 17, wherein (d) includes determining said molar fraction of water in said fluid flow exiting the cathode flow path by performing a mass balance for the cathode flow path.

21. The method of claim 17, wherein (d) includes determining said second temperature based upon said molar fraction of water and a pressure of said fluid flow exiting the cathode flow path.
